(19) United States
(12) Patent Application Publication
(10) Pub. No.: US 2019/0034418 A1
(43) Pub. Date: Jan. 31, 2019

(54) INFORMATION MULTILINGUAL CONVERSION SYSTEM

(71) Applicant: Gurunavi, Inc., Chiyoda-ku (JP)

(72) Inventors: Seiichiro KUBO, Chiyoda-ku (JP); Makito CHIBA, Chiyoda-ku (JP); Hiroto SUMIDA, Chiyoda-ku (JP); Koichiro NAKAYAMA, Chiyoda-ku (JP)

(73) Assignee: Gurunavi, Inc., Chiyoda-ku (JP)

(21) Appl. No.: 15/543,822

(22) PCT Filed: Jan. 15, 2016
(86) PCT No.: PCT/IB2016/000022

§ 371 Date: Jul. 14, 2017

(30) Foreign Application Priority Data
Jan. 16, 2015 (JP) 2015-6453

(51) Int. Cl. G06F 17/28; G06F 9/451

(52) U.S. Cl. CPC G06F 17/289; G06F 9/454

(57) ABSTRACT

An information multilingual conversion system that includes identification name processing circuitry that receives input of an identification name, introduction processing circuitry that receives input of an introduction in a first language, category property information processing circuitry that receives input of at least one of a category and property information, automatic translation circuitry that translates the introduction into a second language, a correspondence foreign-language term storage, foreign-language word conversion circuitry that converts the at least one of the category and the property information into the second language by using the correspondence relation between the first language and the second language, a display information storage, and information display circuitry that, in response to a display request from an information terminal configured to be able to browse various pieces of information, displays the display information on the information terminal.

### BACKGROUND OF THE INVENTION

### 1. Field of the Invention

The invention relates to an information multilingual conversion system that multilingualizes various pieces of information.

### 2. Description of Related Art

In recent years, there are increasing opportunities for foreigners to visit Japan for the purpose of business or sightseeing. Then, when foreigners who are conversant in Japanese visit sightseeing spots, such as temples and museums in many places around Japan, or commercial facilities, such as shopping malls and large electrical appliance stores, such foreigners check points of interest of sightseeing spots, shop information in facilities, information about products, and the like, through webpages, guidebooks or information signs, written in Japanese, and then are able to enjoy sightseeing or purchase desired products without any doubt. On the other hand, foreigners who are not conversant in Japanese or little conversant in Japanese do not understand details described in webpages, guidebooks or information signs, so such foreigners miss points of interest of sightseeing spots or spend wasted time in order to purchase desired products.

As a foreign-language information guide for foreigners who visit sightseeing spots, Japanese Patent Application Publication No. 2005-5938 (JP 2005-5938 A) describes a configuration that an operator provides sightseeing information service for each traveler on the basis of information transmitted from the traveler.

### SUMMARY OF THE INVENTION

However, it is extremely difficult to acquire an operator who is conversant in not only a foreign language but also a sightseeing spot, or the like. In the case of group travel, a rush of requests for information come from a plurality of travelers at a time, and it is obviously not possible to handle such requests if coping with a request from each traveler.

If a guidebook supports a plurality of languages, the number of pages of the guidebook increases in proportion to the number of supported languages, with the result that it is not only inconvenient at the time of sightseeing with the guidebook in traveler's hand but also impeditive when the guidebook is put in a bag, or the like. On the other hand, if an increase in the number of pages of a guidebook is suppressed, the guidebook provides a smaller amount of information, so the guidebook may not describe desired information. If an information sign supports a plurality of languages, the size of the information sign increases with the number of supported languages, with the result that a sightseeing spot may be defiled.

If webpages, guidebooks, information signs, and the like, that support a plurality of languages are created, those require translations by human resources who are conversant in foreign languages. However, not all the sightseeing spots or commercial facilities can acquire such human resources.

The invention provides an information multilingual conversion system that is able to generate various pieces of information compatible with multiple languages even when there are no human resources who are conversant in foreign languages.

An aspect of the invention provides an information multilingual conversion system that generates various pieces of information in multiple languages. The information multilingual conversion system includes: an identification name processing unit that receives input of an identification name that identifies the various pieces of information in a first language, and that assigns an identification code to each identification name; an introduction processing unit that receives input of an introduction of the various pieces of information in the first language in association with the identification code; a category property information processing unit that receives input of at least one of a category and property information of the various pieces of information in association with the identification code; an automatic translation unit that translates the introduction, received by the introduction processing unit, into a second language; a correspondence foreign-language term storage unit that stores a correspondence relation between the first language and the second language for the at least one of the category and the property information; a foreign-language word conversion unit that converts the at least one of the category and the property information to the second language by using the correspondence relation between the first language and the second language, stored in the correspondence foreign-language term storage unit; a display information storage unit that stores, as display information, the identification name received by the identification name processing unit, the introduction translated into the second language by the automatic translation unit, and the at least one of the category and the property information, converted to the second language by the foreign-language word conversion unit; and an information display unit that, in response to a display request from an information terminal configured to be able to browse the various pieces of information, displays the display information, stored in the display information storage unit, on the information terminal.

With this configuration, even when there are no human resources who are conversant in foreign languages, it is possible to allow foreigners who are not conversant in Japanese to easily understand various pieces of information with a simple method. The various pieces of information include, for example, pieces of information associated with a sightseeing spot, a commercial facility or a product. The information terminal is a management terminal that is a computer that is utilized at a management facility (specifically, a facility that manages a sightseeing spot or a commercial facility (including a private shop)) or a computer that is utilized by a user.

In the information multilingual conversion system according to the aspect of the invention, the identification name processing unit may receive input of at least one of an official name indicating the various pieces of information and a simplified name of the official name as the identification name.

With this configuration, as the identification name, an official name that indicates various pieces of information, for example, information associated with a sightseeing spot, a commercial facility or a product, may be input or a name simplified within the range in which a manager of a corresponding facility or product understands the name in Japanese pronounced by a foreigner may be input.

In the information multilingual conversion system according to the aspect of the invention, the identification name processing unit may automatically convert the received identification name to an identification name in writing that allows an intended foreigner to pronounce in the first language, and the display information storage unit may further store the identification name, automatically converted by the identification name processing unit, as display information.

With this configuration, because a sightseeing spot name, a commercial facility name or a product name is automatically converted to a corresponding name in writing that allows pronunciation in the first language, such as Roman alphabet, and is displayed, even foreigners are able to directly pronounce the name in the first language, so the foreigners are able to accurately tell a sightseeing spot name, a commercial facility name or a product name to a guide of a sightseeing spot or a commercial facility or a staff at a shop.

In the information multilingual conversion system according to the aspect of the invention, the information display unit may extract at least one of the official name in the first language and the simplified name in the first language, stored in the display information storage unit, and at least one of the automatically converted official name in writing that allows the intended foreigner to pronounce in the first language and the automatically converted simplified name in writing that allows the intended foreigner to pronounce in the first language, and may display the at least one of the official name in the first language and the simplified name in the first language and the at least one of the automatically converted official name and the automatically converted simplified name on the information terminal.

With this configuration, because a Japanese official name of the identification name and a name in Roman alphabet, simplified from the official name, are, for example, displayed as the identification name, not only Japanese people accurately understand details by looking at various pieces of information but also foreigners are easy to pronounce, so the foreigners are able to easily tell a sightseeing spot name, a commercial facility name or a product name to a guide of a sightseeing spot or a commercial facility or a staff at a shop.

The information multilingual conversion system according to the aspect of the invention may further include an introduction storage unit that stores the category and template information of an introduction related to the category in association with each other, and the introduction processing unit may extract the template information of the introduction corresponding to the category received by the category property information processing unit from the introduction storage unit.

With this configuration, because it is possible to create an introduction on the basis of the template of an introduction associated with a category, so it is possible to reduce burden of work for inputting an introduction.

In the information multilingual conversion system according to the aspect of the invention, when the introduction processing unit has received input of revision to the introduction in the first language, the automatic translation unit may automatically translate the introduction, to which the input of revision in the first language has been received by the introduction processing unit, into the second language.

The introduction is a point that is desired to have originality for each sightseeing spot or each commercial facility, and is less fixed information. With this configuration, by receiving free input in the first language as needed and executing automatic translation processing, it is possible to provide less fixed information to foreigners.

In the information multilingual conversion system according to the aspect of the invention, when the category property information processing unit has received input of revision in the first language to the at least one of the category and the property information, the foreign-language word conversion unit may automatically convert the at least one of the category and the property information, to which the input of the revision in the first language has been received, into the second language.

Categories, such as temple, art museum, supermarket and camera, and property information, that is, in-facility information, such as the presence or absence of a restroom, a smoking area or a nursing room, available languages, whether credit-card payment is accepted, and whether it is duty-free, are highly fixed information. With this configuration, it is possible to reduce burden of input work at a management facility or a shop.

The information multilingual conversion system according to the aspect of the invention may further include a search processing unit that receives a first search condition in the second language from the information terminal, that identifies a word in the first language, corresponding to the first search condition, as a second search condition, that searches for display information that is stored in the display information storage unit and that is appropriate for the first search condition and the second search condition, and that provides the appropriate display information to the information terminal.

With this configuration, when a foreigner who is not conversant in Japanese utilizes a various information providing site, it is possible to search for various pieces of information appropriate for a search condition in a language that the foreigner understands.

In the information multilingual conversion system according to the aspect of the invention, the search processing unit may receive at least one of a category and property information as a category and property information search condition, searches for display information that is stored in the display information storage unit and that is appropriate for the category and property information search condition, and provides the appropriate display information to the information terminal.

With this configuration, when a foreigner who is not conversant in Japanese utilizes a various information providing site, it is possible to search for various pieces of information appropriate for a search condition in which a category or property information is set.

In the information multilingual conversion system according to the aspect of the invention, the category property information processing unit may receive input of positional information, and the information display unit may display the positional information.

With this configuration, because positional information is displayed, a foreigner who is not conversant in Japanese is allowed to do sightseeing without getting lost as for a sightseeing spot, and is allowed to go to a desired shop as for a commercial facility. In addition, a foreigner who is not conversant in Japanese is allowed to go to a place at which a product that the foreigner wants to purchase is displayed, and check an actual product.

The information multilingual conversion system according to the aspect of the invention may further include a category property information storage unit that stores at least one set of categories and pieces of property information, which are choices for receiving input of a selected one of a category and property information, and the category property information processing unit may extract choices for at least one of a category and property information on the basis of the at least one set of categories and pieces of property information.

The information multilingual conversion system according to the aspect of the invention may further include an image information processing unit that receives input of image information.

With the information multilingual conversion system according to the aspect of the invention, even when there are no human resources who are conversant in foreign languages, it is possible to easily allow a foreigner who is not conversant in

Japanese to understand various pieces of information about, for example, a sightseeing spot, a commercial facility or a product, with a simple method, so the foreigner is allowed to go to an intended place without getting lost and purchase a desired product.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a conceptual view that schematically shows an example of the system configuration of an information multilingual conversion system according to an embodiment of the invention;

FIG. 2 is a conceptual view that schematically shows an example of the configuration of an information processing unit according to the embodiment of the invention;

FIG. 3 is a conceptual view that schematically shows an example of the configuration of a master storage unit according to the embodiment of the invention;

FIG. 4 is a conceptual view that schematically shows an example of the hardware configuration of a computer that causes the information multilingual conversion system according to the embodiment of the invention to function;

FIG. 5 is a flowchart that schematically shows an example of the processing process of the information multilingual conversion system according to the embodiment of the invention;

FIG. 6 is a view that schematically shows an example of a management screen according to the embodiment of the invention; FIG. 7 is a view that schematically shows an example of a state where a sightseeing spot name is input to the management screen shown in FIG. 6;

FIG. 8 is a view that schematically shows an example of a state where an image is input to the management screen shown in FIG. 7;

FIG. 9 is a view that schematically shows an example of a state where a category is input to the management screen shown in FIG. 8;

FIG. 10 is a view that schematically shows an example of a state where property information is reflected in the management screen shown in FIG. 9;

FIG. 11 is a view that schematically shows another example of the management screen according to the embodiment of the invention;

FIG. 12 is a view that schematically shows an example of a screen in the case where a shop list of commercial facilities is displayed by the use of the information multilingual conversion system according to the embodiment of the invention;

FIG. 13 is a view that schematically shows an example of a screen in the case where a product list is displayed by the use of the information multilingual conversion system according to the embodiment of the invention; and

FIG. 14 is a conceptual view that schematically shows an example of the system configuration of an information multilingual conversion system according to another embodiment of the invention.

### DETAILED DESCRIPTION OF EMBODIMENTS

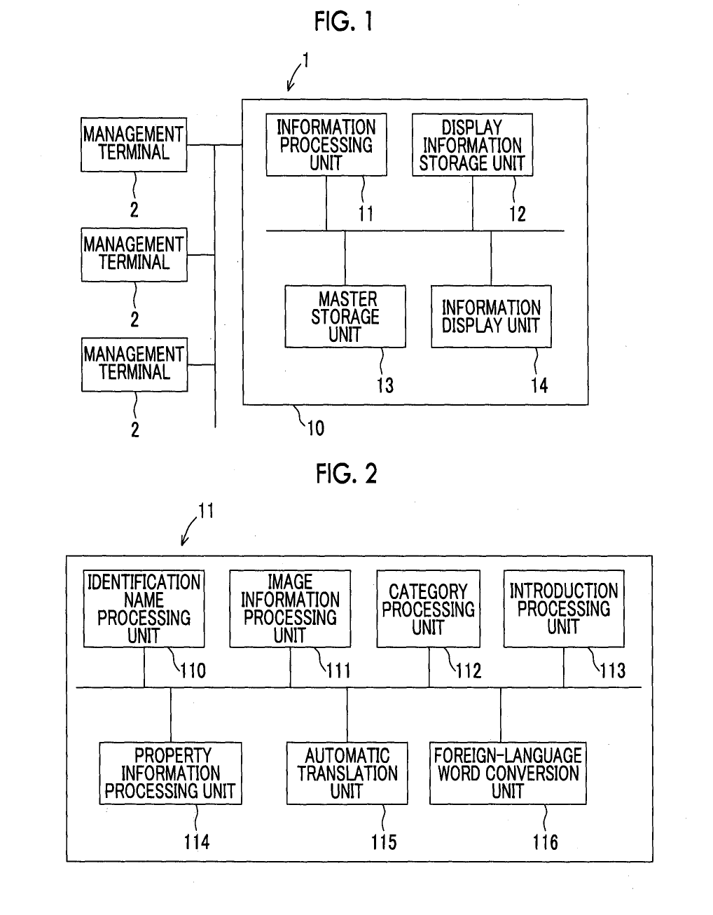

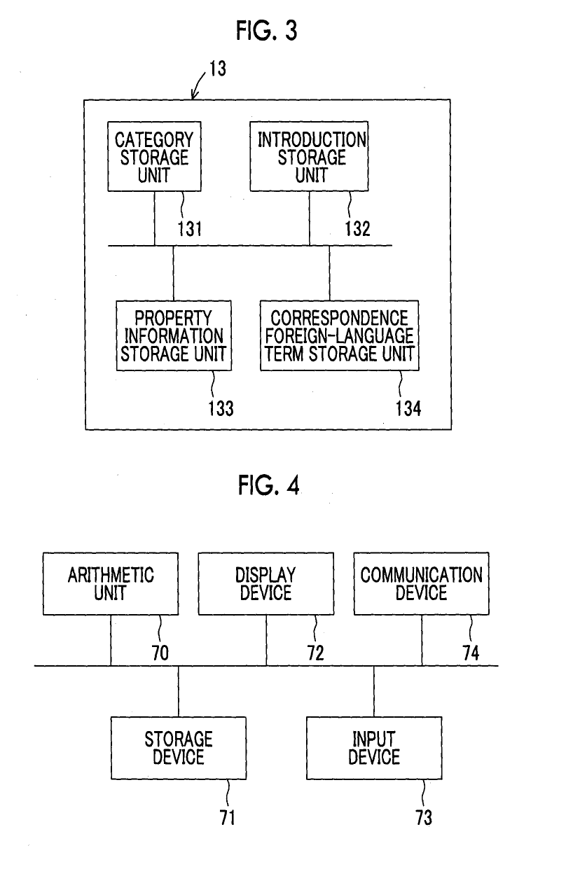

An information multilingual conversion system according to an embodiment of the invention will be described with reference to the accompanying drawings. FIG. 1 is a conceptual view that schematically shows an example of the system configuration of the information multilingual conversion system according to the embodiment of the invention. FIG. 2 is a conceptual view that schematically shows an example of the configuration of an information processing unit according to the embodiment of the invention. FIG. 3 is a conceptual view that schematically shows an example of the configuration of a master storage unit according to the embodiment of the invention.

The information multilingual conversion system 1 according to the present embodiment is implemented by a computer including a server, and the like. As shown in FIG. 4, the computer includes an arithmetic unit 70, a storage device 71, a display device 72, an input device 73 and a communication device 74. The arithmetic unit 70 is, for example, a CPU, and executes arithmetic processing in accordance with a program. The storage device 71 is, for example, a RAM or a hard disk, and stores information. The display device 72 is, for example, a display, and provides a display image. The input device 73 is, for example, a mouse, a keyboard or a touch panel for input. The communication device 74 exchanges the results processed by the arithmetic unit 70 and information stored in the storage device 71 with another computer.

The units according to the embodiment of the invention may be just logically distinguished in function from one another, and may constitute the same area physically or practically. The information multilingual conversion system 1 according to the embodiment of the invention may be implemented by a single server or may be distributed to two or more servers. Part or all of the functions according to the embodiment of the invention may be implemented by a computer (including a portable communication terminal, such as a cellular phone) that is used by a user who searches for a sightseeing spot, a commercial facility or a product. Particularly, the processing of an automatic translation unit 115, foreign-language word conversion unit 116, information display unit 14 (described later), and the like, may be executed by a user's computer. Thus, it is possible to reduce the processing load of an administrative server 10.

The administrative server 10 including the functions of the information multilingual conversion system 1 is able to exchange information with management terminals 2 via a network, such as the Internet. The management terminals 2 are computers that are respectively used at management facilities (specifically, facilities that manage sightseeing spots or commercial facilities (including private shops)). Each of the management terminals 2 just needs to be a computer, and includes not only a personal computer but also a portable communication terminal, and the like. The portable communication terminal includes a cellular phone including a smartphone, a PHS, a tablet computer, and the like.

The administrative server 10 in the information multilingual conversion system 1 according to the present embodiment includes an information processing unit 11, a display information storage unit 12, a master storage unit 13 and the information display unit 14. The case where Japanese is the first language, which is a language in the country in which service using the information multilingual conversion system 1 according to the present embodiment is rolled out, will be described. However, when the service is rolled out in another country, a language that is used in that country may be employed as the first language. A second language means one or multiple languages (foreign languages for that country) other than the first language.

The information processing unit 11 includes an identification name processing unit 110, an image information processing unit 111, a category processing unit 112, an introduction processing unit 113, a property information processing unit 114, the automatic translation unit 115 and the foreign-language word conversion unit 116.

The information processing unit 11 receives input information about products or services that are handled at a sightseeing spot, a commercial facility, a shop, or the like, managed at a management facility and that are transmitted from the corresponding management terminal 2. The information processing unit 11 stores pieces of information, resulting from various processes on the received input information in the processing units, in the display information storage unit 12 (described later) as display information.

Input information about a sightseeing spot includes the name of a sightseeing spot (a temple, a museum, a tower, a theme park, a natural landscape, such as a mountain and a lake, or the like), an image that shows the point of interest, or the like, of a sightseeing spot, a category (temple, museum, tower, or the like), an introduction (point of interest, or the like), facility information (the presence or absence of a restroom, a smoking area or a nursing room, or the like) and positional information (floor map).

Input information about a commercial facility includes the name of a commercial facility (a private shop, a supermarket, and a commercial complex, such as a shopping mall), an image that shows the external appearance, or the like, of a facility or a shop, a category (fashion, interior, service, gourmet, foods, or the like), an introduction (sale information, or the like), facility information (the presence or absence of a restroom, a smoking area or a nursing room, whether credit-card payment is accepted, whether it is duty-free, available languages, or the like) and positional information (floor map).

Input information about a product includes a product name, the image of a product, a category (in the case of an electrical appliance store, personal computer, music player, home appliance, or the like), an introduction (the appeal point, or the like, of a product), product information (manufacturer, brand, product identification number, such as model number, or retail price) and positional information (product display information).

The above-described pieces of input information are only illustrative, and may be modified as needed. For example, the input information about a sightseeing spot may include price information (admission fee, or the like), business hours information, location information (address or residence), access information (information about public transportation, such as the nearest station, the presence or absence of a parking lot, a shuttle bus, or the like), contact information (phone number, fax number, or e-mail address). The input information about a commercial facility may include price information (the price range of products handled), business hours information, location information (address or residence), access information (information about public transportation, such as the nearest station, or the presence or absence of a parking lot), and contact information (phone number, fax number or e-mail address). The input information about a product may include inventory information, remarks information (working voltage, the presence or absence of an English instruction manual) and shop information.

The identification name processing unit 110 receives an identification name for identifying various pieces of information, such as a sightseeing spot name, a commercial facility name and a product name, and assigns an identification code to each received identification name. A sightseeing spot name, a commercial facility name or a product name is written in not only kanji, hiragana or katakana but also alphabets, numerals, symbols or a coined word obtained by combining these characters or symbols, so the identification name processing unit 110 should receive the input of a sightseeing spot name, a commercial facility name or a product name in katakana. The identification code is a discrimination ID or identification number composed of a plurality of alphabets, numerals, and the like, and is assigned in order to identify various pieces of information for each identification name.

The identification name processing unit 110 converts the received sightseeing spot name, commercial facility name or product name to the sightseeing spot name, commercial facility name or product name in Roman alphabet that allows even an intended foreigner to pronounce the sightseeing spot name, commercial facility name or product name in Japanese. Specifically, when the input of a sightseeing spot name, commercial facility name or product name in katakana has been received, the identification name processing unit 110 should convert the sightseeing spot name, commercial facility name or product name to those in Roman alphabet that allows even an intended foreigner to pronounce in Japanese on the basis of katakana writing. The input in katakana does not require inputting a sightseeing spot name, a commercial facility name or a product name in official name, and may be a name simplified within the range in which a manager of a corresponding facility understands the name in Japanese pronounced by a foreigner. For example, “ [symbol] [symbol] ” (i.e. “Tokyo International Airport” in Katakana/angular Japanese phonetic syllabary) may be input as the official name of a sightseeing spot name or a simplified name “ [symbol] ” (i.e. “Haneda Airport” in Katakana) may also be input. The identification name processing unit 110 may receive not the input of a sightseeing spot name, commercial facility name or product name in katakana but the input of a sightseeing spot name, commercial facility name or product name in Roman alphabet. As long as writing allows pronunciation in Japanese, any writing other than Roman alphabet is also applicable.

The identification name processing unit 110 may convert an identification name into a predetermined display mode, and may cause an information terminal to display the identification name by the information display unit 14 (described later). The information terminal is configured to be able to browse various pieces of information. Specifically, when the official name “TOKYOKOKUSAIKUKO” in Roman alphabet and the simplified name “HANEDAKUKO” in Roman alphabet are provided for “ [symbol] [symbol] ” (“Tokyo International Airport” in Kanji/Chinese Character) in Japanese, the identification name processing unit 110 is able to convert the identification name into the predetermined display mode composed of “ [symbol] ” (“Tokyo International Airport” in Kanji) in Japanese and the simplified name “HANEDAKUKO” in Roman alphabet, and is able to cause the information terminal to display the identification name by the information display unit 14 (described later). The identification name processing unit 110 may also be configured in advance so as to convert the identification name into the display mode composed of “ [symbol] ” (“Tokyo International Airport” in Kanji) and the official name “TOKYOKOKUSAIKUKO” in Roman alphabet.

The identification name processing unit 110 may receive the input of a selected display mode of the identification name. Specifically, when the official name “TOKYOKOKUSAIKUKO” in Roman alphabet and the simplified name “HANEDAKUKO” in Roman alphabet are provided for “ [symbol] ” (“Tokyo International Airport” in Kanji), the identification name processing unit 110 receives the input of any selected one of the display mode composed of “ [symbol] ” (“Tokyo International Airport” in Kanji) and the official name “TOKYOKOKUSAIKUKO” in Roman alphabet and the display mode composed of “ [symbol] ” (“Tokyo International Airport” in Kanji) and the simplified name “HANEDAKUKO” in Roman alphabet. The selected one of the display modes is displayed on the information terminal by the information display unit 14 (described later).

The image information processing unit 111 receives the input of image information of a sightseeing spot, a commercial facility or a product. The file format of an image is not specifically limited, and an image may be not only a still image but also a moving image.

The category processing unit 112 receives the input of a selected category to which the sightseeing spot, commercial facility or product belongs. The category processing unit 112 associates the received category with the identification code assigned to each identification name. Categories to be selected are stored in a category storage unit 131 of the master storage unit 13 (described later). The category processing unit 112 receives the input of a selected category by consulting the category storage unit 131 and then displaying choices.

The introduction processing unit 113 extracts the template information of a corresponding introduction of a sightseeing spot, commercial facility or product from an introduction storage unit 132 of the master storage unit 13 (described later) on the basis of the information about the category selected and received by the category processing unit 112, and displays the template information of the introduction. The introduction processing unit 113 associates the received introduction with the identification code assigned to each identification name.

When a change selection of the introduction of the sightseeing spot, commercial facility or product has been received, the introduction processing unit 113 receives the input of an introduction of the sightseeing spot, commercial facility or product in Japanese. The introduction of a sightseeing spot, commercial facility or product includes the point of interest of a sightseeing spot, sale information of each shop of a commercial facility, the appeal point of a product, and the like. The introduction processing unit 113 may receive the input of an introduction from the beginning without using template information.

When the information about the category selected and received by the category processing unit 112 is a sightseeing spot or a commercial facility, the property information processing unit 114 extracts the template information of corresponding property information, such as in-facility information (the presence or absence of a restroom, a smoking area or a nursing room, available languages, whether credit-card payment is accepted, and whether it is duty-free) and positional information (floor map), from a property information storage unit 133 of the master storage unit 13 (described later) on the basis of the information about the category, and displays the template information of the property information. The property information processing unit 114 associates the received property information with the identification code assigned to each identification name.

When the property information processing unit 114 has received a change selection of the in-facility information or positional information, the property information processing unit 114 receives the input of the selection for the in-facility information or positional information by consulting the property information storage unit 133. Pieces of property information that are pieces of in-facility information or pieces of positional information to be selected are stored in the property information storage unit 133 of the master storage unit 13 (described later). The property information processing unit 114 receives the input of a selected piece of property information by consulting the property information storage unit 133 and then displaying choices of the property information. The property information in the case where the information about the category is a sightseeing spot or a commercial facility is not limited to in-facility information or positional information, and may be set as needed.

When the information about the category selected and received by the category processing unit 112 is a product, the property information processing unit 114 may extract the template information of corresponding product information (manufacturer, brand, product identification number, such as model number, or retail price) from the property information storage unit 133 of the master storage unit 13 (described later) on the basis of the information about the category, and then may display the template information of the product information. When the property information processing unit 114 has received a change selection of product information as well, the property information processing unit 114 receives the input of the selection for product information by consulting the property information storage unit 133. Pieces of property information that are pieces of product information to be selected are stored in the property information storage unit 133 of the master storage unit 13 (described later). The property information processing unit 114 receives the input of a selected piece of property information by consulting the property information storage unit 133 and then displaying choices of the property information. The property information in the case where the information about the category is a product is not limited to product information, and may be set as needed.

The property information processing unit 114 may receive the input of a selected piece of property information by consulting the property information storage unit 133 and then displaying choices of the property information from the beginning without using template information.

The property information processing unit 114 may receive, as the positional information, a map on which marks are placed at points of interest in the case of a sightseeing spot, a floor map on which marks are placed at shops in the case of a commercial facility or a map on which display locations of products can be checked in the case of a product.

The above-described category processing unit 112 and property information processing unit 114 are separately described one by one for the sake of convenience of description; instead, the category processing unit 112 and the property information processing unit 114 may be configured as a category property information processing unit that receives the input of a category and the input of property information.

When the sentence that introduces a sightseeing spot, a commercial facility or a product is changed by the introduction processing unit 113 and the input of the changed sentence has been received, the automatic translation unit 115 translates the changed sentence into a sentence in a foreign language with the use of a known translation processing function. Various translation functions may be used. The function of translating a sentence on a website may be used.

The foreign-language word conversion unit 116 automatically converts the pieces of input information received by the information processing unit 11 to corresponding foreign-language words on the basis of a correspondence table between words in Japanese, which is the first language, and words in at least one foreign language, which is the second language. The correspondence table is stored in a correspondence foreign-language term storage unit 134 of the master storage unit 13 (described later). Specifically, the foreign-language word conversion unit 116 automatically converts the category and property information in Japanese to corresponding foreign-language words on the basis of the correspondence table. The foreign-language word conversion unit 116 may be configured to automatically convert both the category and the property information or only any one of the category and the property information to a corresponding foreign-language word.

The information processing unit 11 may receive, as the input information for a sightseeing spot, price information, such as admission fee, business hours information, location information, information about public transportation, such as the nearest station, access information, such as information about the presence or absence of a parking lot or a shuttle bus, and contact information, such as phone number, fax number and e-mail address. The information processing unit 11 may receive, as the input information for a commercial facility, price information (the price range of products handled), business hours information, location information, information about public transportation, such as the nearest station, access information, such as information about the presence or absence of a parking lot, and contact information, such as phone number, fax number and e-mail address. The information processing unit 11 may add, as the input information for a product, remarks information, such as working voltage and the presence or absence of an English instruction manual.

The display information storage unit 12 stores pieces of information, received by the information processing unit 11 and processed by the processing units, as display information for each sightseeing spot, each commercial facility or each product. For example, the display information storage unit 12 stores, as the display information, the sightseeing spot name in Japanese, received by the identification name processing unit 110, the sightseeing spot name in Roman alphabet, automatically converted by the identification name processing unit 110, the foreign-language introduction on which the automatic translation unit 115 has executed automatic translation process, the category and property information converted into foreign-language words by the foreign-language word conversion unit 116, and the like.

The master storage unit 13 stores necessary pieces of information in a master table in order to generate various pieces of information in foreign-language words in the information processing unit 11. The master storage unit 13 includes the category storage unit 131, the introduction storage unit 132, the property information storage unit 133 and the correspondence foreign-language term storage unit 134.

The category storage unit 131 stores information about categories that are choices for receiving the input of a selected category of a sightseeing spot, a commercial facility or a product by the category processing unit 112. Categories are stored by hierarchical structure. For example, categories are stored so as to be classified into a large classification, a middle classification narrower than the large classification, and a small classification further narrower than the middle classification. As for the category of a sightseeing spot, the large classification includes, for example, facility, natural landscape, and the like. The middle classification includes, for example, temple, museum, tower, art museum, theater, aquarium, and the like, when the large classification is facility. In this way, the category processing unit 112 is able to receive the input of a selected category by displaying choices of category on the basis of the categories stored in the category storage unit 131.

The introduction storage unit 132 stores the template information of an introduction related to the category selected by the category processing unit 112. That is, each category and the template of the introduction related to the category are stored in association with each other. For example, “A view from the sightseeing tower is beautiful.” is stored in association with the category “tower” as the template of the introduction. Specifically, when the category “tower” is selected, the introduction processing unit 113 extracts the template information of an introduction related to “tower” and stored in the introduction storage unit 132, and displays the template information.

The property information storage unit 133 stores pieces of in-facility information that are choices for receiving the input of a selected piece of in-facility information (the presence or absence of a restroom, a smoking area or a nursing room, available languages, whether credit-card payment is accepted, and whether it is duty-free) by the property information processing unit 114. In-facility information may be sorted in association with information of a category, or the property information processing unit 114 may extract in-facility information associated with the category selected by the category processing unit 112 by consulting the property information storage unit 133, and then display the extracted in-facility information as the template in-facility information.

The property information storage unit 133 stores pieces of positional information that are choices for receiving the input of a selected piece of positional information (floor map) by the property information processing unit 114. Positional information may be stored in association with information of a category, or the property information processing unit 114 may extract positional information associated with the category selected by the category processing unit 112 by consulting the property information storage unit 133, and then display the extracted positional information as the template positional information. The property information storage unit 133 may store, as the positional information, a map on which marks are placed at points of interest in the case of a sightseeing spot, a floor map on which marks are placed at shops in the case of a commercial facility or a map on which display locations of products can be checked in the case of a product, received by the property information processing unit 114.

The property information storage unit 133 stores pieces of product information that are choices for receiving the input of a selected piece of product information (manufacturer, brand, product identification number, such as model number, or retail price) by the property information processing unit 114. Product information may be stored in association with information of a category, or the property information processing unit 114 may extract product information associated with the category selected by the category processing unit 112 by consulting the property information storage unit 133, and then display the extracted product information as the template product information.

The correspondence foreign-language term storage unit 134 is a correspondence table between Japanese (first language) and at least one foreign language (second language) for the category to which a sightseeing spot, a commercial facility or a product to receive the input by the category processing unit 112 belongs, the template information of an introduction to receive by the introduction processing unit 113, the template information of the in-facility information, positional information or product information to receive by the property information processing unit 114, and the like.

When the information display unit 14 has received a request to display various pieces of information from an information terminal (including the management terminal 2 and a computer that is used by a user) configured to be able to browse various pieces of information, the information display unit 14 extracts the display information of a sightseeing spot, a commercial facility or a product from the display information storage unit 12, and causes the information terminal to display the display information. The display information is each piece of information after the processing process of the information multilingual conversion system 1 (described later) has been executed on the basis of the input information of a sightseeing spot, a commercial facility or a product. Specifically, the display information includes information of a sightseeing spot name, commercial facility name and product name in Japanese and a sightseeing spot name, commercial facility name and product name in Roman alphabet, received by the identification name processing unit 110, information of introductions automatically translated in the intended language from introductions of the sightseeing spot, commercial facility and product by the automatic translation unit 115, property information automatically converted in the intended language from in-facility information (available languages, and the like, whether credit-card payment is accepted, and whether it is duty-free) by the foreign-language word conversion unit 116, and the like.

The information display unit 14 just needs to be able to receive the input of a selected show/hide mode for each piece of the display information stored in the display information storage unit 12. For example, the information display unit 14 extracts at least one of an official name in the first language and a simplified name in the first language, stored in the display information storage unit 12, and at least one of an automatically converted official name in writing that allows intended foreigners to pronounce in the first language and an automatically converted simplified name in writing that allows intended foreigners to pronounce in the first language, and then displays the extracted names on an information terminal. Specifically, when not only an official name in Japanese and an official name in Roman alphabet but also a simplified name in Japanese simplified from the official name and a simplified name in Roman alphabet simplified from the official name are provided as information of a sightseeing spot name, commercial facility name or product name in Japanese and a sightseeing spot name, commercial facility name or product name in Roman alphabet, the information display unit 14 may display the official name in Japanese and the simplified name in Roman alphabet simplified from the official name. That is, Japanese people accurately understand a sightseeing spot name, a commercial facility name and a product name by looking at an official name in Japanese. On the other hand, foreigners are easy to pronounce when a simplified name in Roman alphabet is provided, so foreigners are able to easily tell a sightseeing spot name, a commercial facility name or a product name to a guide in a sightseeing spot or a commercial facility or a staff at a shop. The information display unit 14 may display a simplified name in Japanese and a corresponding official name in Roman alphabet, and is able to change a combination of names displayed as needed.

As described above, the information multilingual conversion system 1 according to the present embodiment is able to multilingualize various pieces of information with an optimal method by considering the characteristics of the identification name, introduction and property information of various pieces of information and then respectively subjecting the identification name, introduction and property information of various pieces of information to suitable processes.

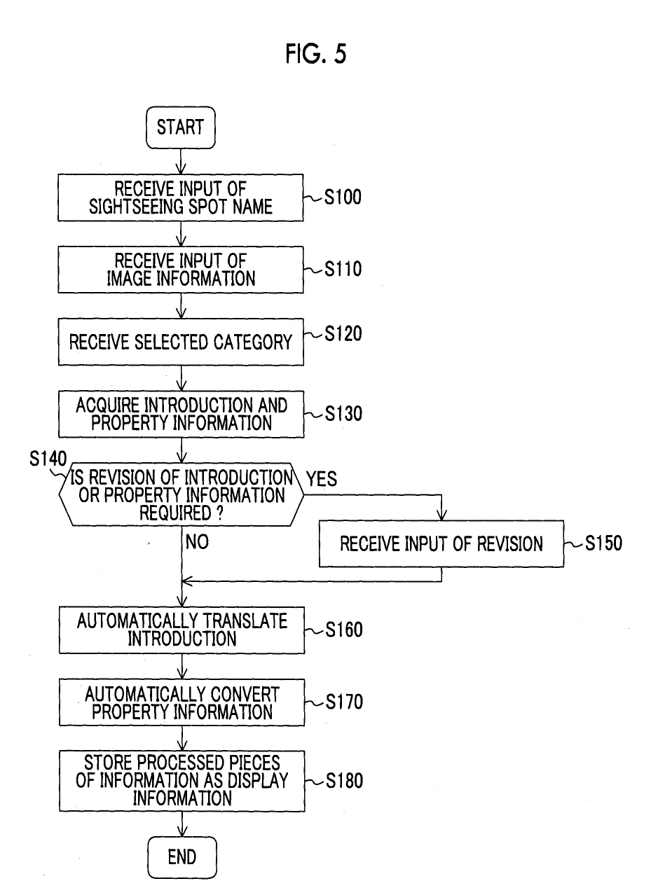

Next, an example of the processing process of the information multilingual conversion system 1 will be described below with reference to the flowchart of FIG. 5.

A facility that manages a sightseeing spot or a commercial facility accesses to the information multilingual conversion system 1 of a corporation that manages information providing service for the sightseeing spot by performing a predetermined operation, and inputs operation to generate various pieces of information in a foreign language.

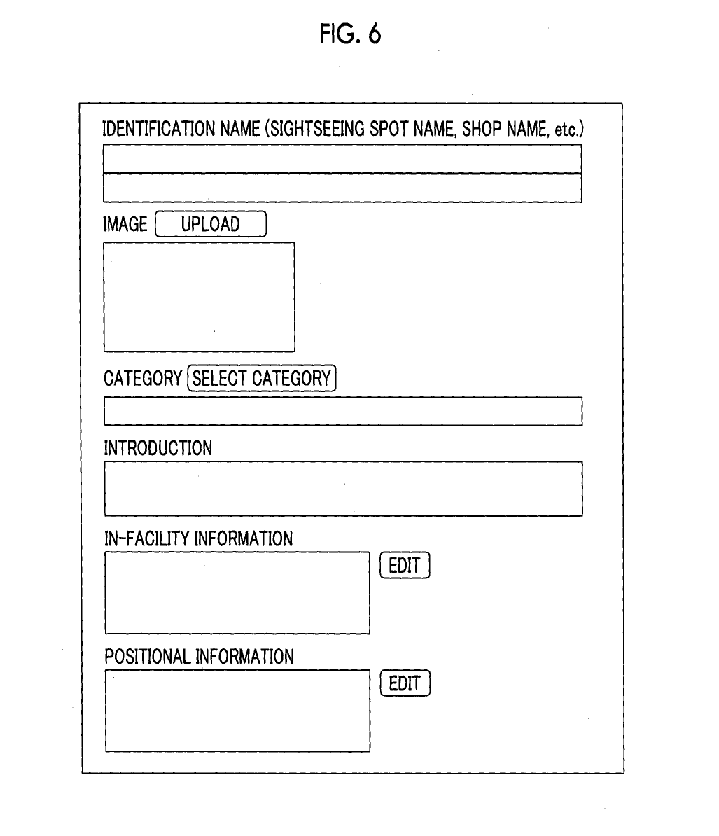

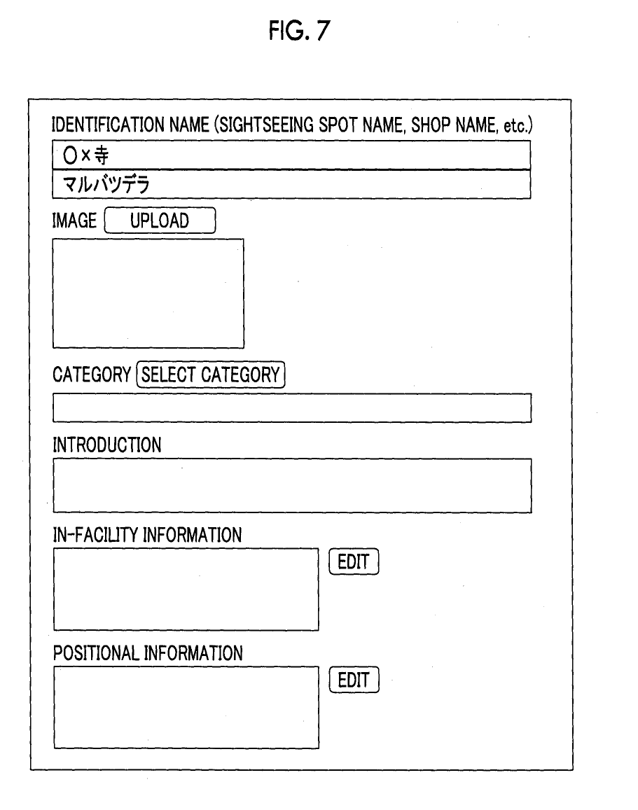

When the input of the operation has been received by the administrative server 10, the information processing unit 11 causes the management terminal 2 to display a management screen shown in FIG. 6, and then allows the input of information about the sightseeing spot on the management terminal 2. Initially, the identification name processing unit 110 of the information processing unit 11 receives the input of a sightseeing spot name on the management screen (S100). Specifically, the identification name processing unit 110 receives the input of a sightseeing spot name in actual writing composed of kanji, and the like, and a sightseeing spot name in katakana. The actual writing of a sightseeing spot name may be, for example, “ [symbol] ” (“Tokyo International Airport” in Kanji) that is an official name or may be “ [symbol] ” (“Haneda Airport” in Kanji) that is a simplified name.

The identification name processing unit 110 automatically converts the received sightseeing spot name in katakana to a sightseeing name in Roman alphabet. The identification name processing unit 110 may receive the input of a sightseeing spot name in Roman alphabet instead of a sightseeing spot name in katakana. In this case, the process of converting a sightseeing spot name in katakana to a sightseeing spot name in Roman alphabet is not necessary. In addition, the identification name processing unit 110 assigns an identification code unique to a received sightseeing spot name.

For example, when the sightseeing spot name is “ο× [symbol] ”(“Marubatsu Temple” in Kanji), the identification name processing unit 110 receives the input of “ο× [symbol] ”(“Marubatsu Temple” in Kanji) and “ [symbol] ” (“Marubatsu Temple” in Katakana) as the sightseeing spot name. The identification name processing unit 110 converts “ [symbol] ” (“Marubatsu Temple” in Katakana) to “MARUBATSUDERA”. FIG. 7 shows an example of the management screen in the case where the sightseeing spot name is input.

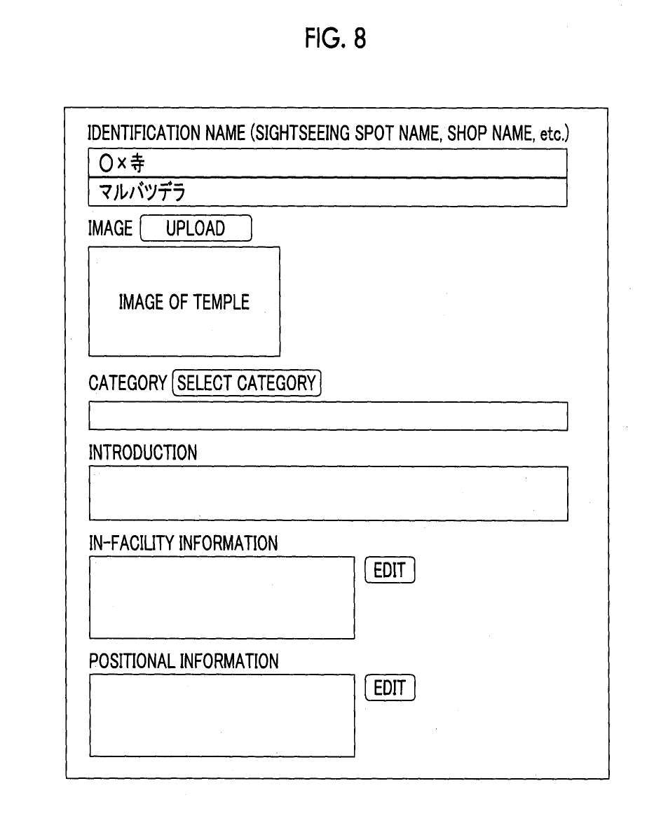

Subsequently, when “UPLOAD” button image is selected on the management screen, a screen for uploading the image information of the sightseeing spot is displayed. When image information to be uploaded is selected on the screen, the image information of the sightseeing spot is transmitted from the management terminal 2 to the administrative server 10. The image information of the sightseeing spot is received by the image information processing unit 111 of the information processing unit 11 (S110). FIG. 8 shows an example of the management screen in the case where the image of the sightseeing spot is input.

When “SELECT CATEGORY” button is selected on the management screen by the management terminal 2, the category processing unit 112 of the information processing unit 11 receives the fact that “SELECT CATEGORY” button is selected. The category processing unit 112 consults the category storage unit 131 in the master storage unit 13, and then displays choices for the category of the sightseeing spot on the management screen. A manner of displaying choices includes various manners, such as a manner using a pull-down menu, a manner using checkboxes, and a manner using a pop-up window. Any manner may be employed.

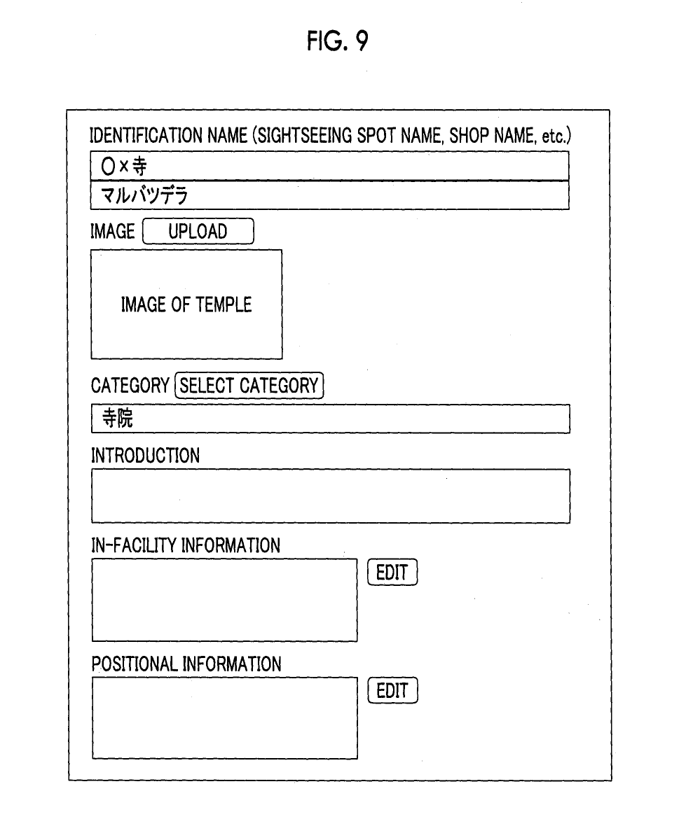

For example, if “temple” is selected within “facility” (large classification), the category processing unit 112 receives the input of the selection (S120). FIG. 9 shows an example of the management screen in the case where the category is input.

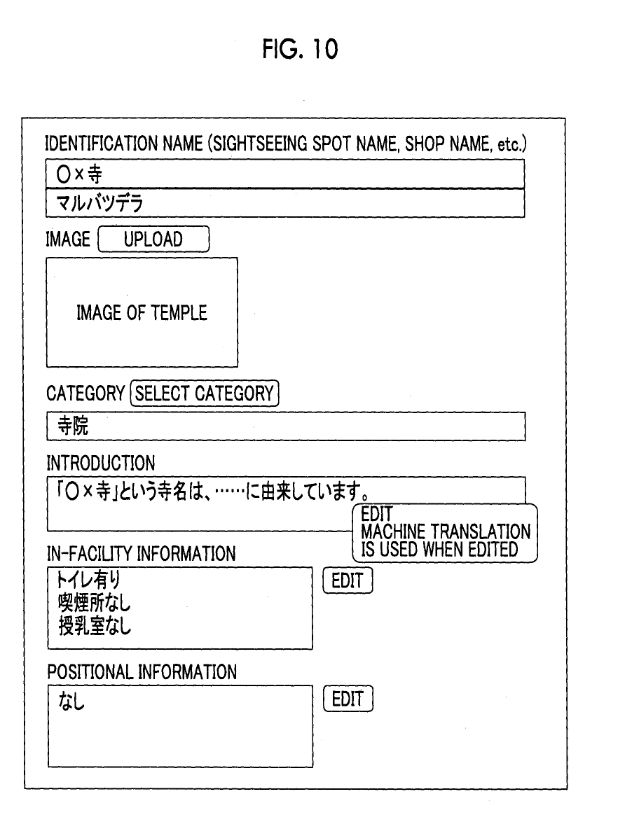

When the category processing unit 112 receives a selected category, the introduction processing unit 113 and the property information processing unit 114 acquire the pieces of template information respectively corresponding to the introduction, property information, and the like, corresponding to the selected category by consulting the introduction storage unit 132 and the property information storage unit 133 in the master storage unit 13 (S130). The introduction processing unit 113 and the property information processing unit 114 display those pieces of template information on the management screen. FIG. 10 shows an example of the management screen in the case where the pieces of template information of the introduction and property information are displayed.

If the pieces of template information of the introduction and property information are revised (S140), edition is allowed by selecting “EDIT” buttons respectively allocated to the introduction and the property information, and the input is received (S150). At this time, the introduction processing unit 113 receives the input of the introduction in Japanese. As for the property information, that is, the in-facility information and the positional information, when any one of “EDIT” buttons respectively allocated to the in-facility information and the positional information is selected, the property information processing unit 114 consults the property information storage unit 133 in the master storage unit 13, displays choices on the management screen, and then receives the input of a selected choice.

As described above, the input of the identification name, introduction, property information, or the like, is received as input information. When the details are revised by the introduction processing unit 113, the automatic translation unit 115 executes the process of automatically translating the Japanese introduction received by the introduction processing unit 113 into the introduction in a predetermined foreign language, such as English, French, German, Spanish, Chinese and Arabic (S170). On the other hand, when the details of the introduction are not revised, the foreign-language word conversion unit 116 executes automatic conversion processing by searching the correspondence foreign-language term storage unit 134 for a foreign-language term corresponding to the introduction and identifying the foreign-language term of the selected introduction (S160).

In addition, the foreign-language word conversion unit 116 executes automatic conversion processing by consulting the correspondence foreign-language term storage unit 134 on the basis of the selected property information received by the property information processing unit 114 and then identifying a foreign-language word of the selected property information (S170). The automatic translation processing of the automatic translation unit 115 or the automatic conversion processing of the foreign-language word conversion unit 116 may be not executed in advance but executed at any timing.

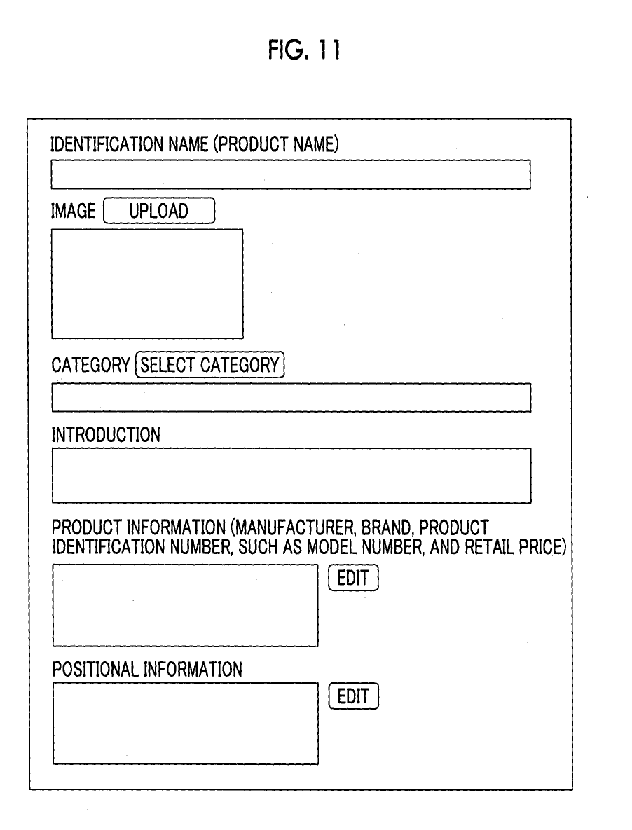

By executing the above-described processing, the information processing unit 11 stores the processed pieces of information in the display information storage unit 12 (S180). For example, the display information storage unit 12 stores, as display information, the sightseeing spot name in Japanese, received by the identification name processing unit 110, the sightseeing spot name in Roman alphabet, automatically converted by the identification name processing unit 110, foreign-language introduction automatically translated by the automatic translation unit 115, and the category, property information, and the like, converted into foreign-language words by the foreign-language word conversion unit 116. As for a commercial facility, similar processing to the above-described processing may be executed. As for a product, the information processing unit 11 causes the intended management terminal 2 to display a management screen shown in FIG. 11, and then allows the input of information about the product on the management terminal 2. After that, processing similar to the above-described processing is executed.

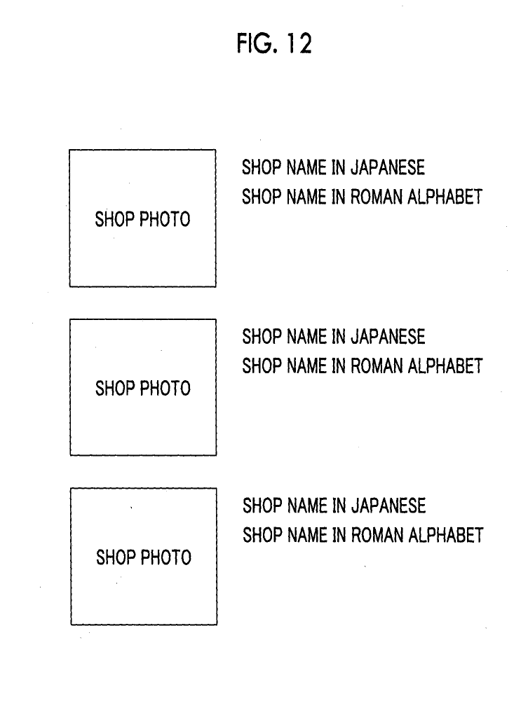

In a first example of the information multilingual conversion system 1 according to the present embodiment, when a foreigner visits a shopping mall, an information guide of the shopping mall accesses to the administrative server 10 by performing a predetermined operation with the use of a portable communication terminal, or the like, and hands the portable communication terminal to the foreigner. When the foreigner selects his or her own understandable language, or the like, with the use of the portable communication terminal, an information display unit 14 displays a guide page translated in the understandable language as shown in FIG. 12. For example, information of a shop name in Japanese and in Roman alphabet and the photo of the shop should be displayed in a list form.

When a shop name, or the like, is selected from the list, the portable communication terminal issues a request to acquire the corresponding display information to the administrative server 10. The information display unit 14 displays the display information of the selected shop, corresponding to the language selected by the foreigner, from the display information storage unit 12. The display information includes, for example, information of the shop name in Japanese and in Roman alphabet, information of an introduction automatically translated from the introduction of the shop in the selected language, and property information automatically converted from in-facility information (available languages, and the like, whether credit-card payment is accepted, and whether it is duty-free) in the selected language. The shop name in Roman alphabet may be a converted shop name in Roman alphabet that allows even an intended foreigner to pronounce in Japanese on the basis of the shop name in katakana as described above. In addition, only any one of information of the shop name in Japanese and information of the shop name in Roman alphabet may be displayed. The information display unit 14 may display a photo that shows the external appearance of the shop, a floor map on which a mark is placed at the shop location, and the like.

The in-facility information, such as the presence or absence of a restroom, a smoking area and a nursing room, business hours information, and the like, may also be displayed on the translated guide page. Even when the foreigner visits the shopping mall for the first time, the foreigner is allowed to visit the intended shop without no doubt, and enjoy shopping.

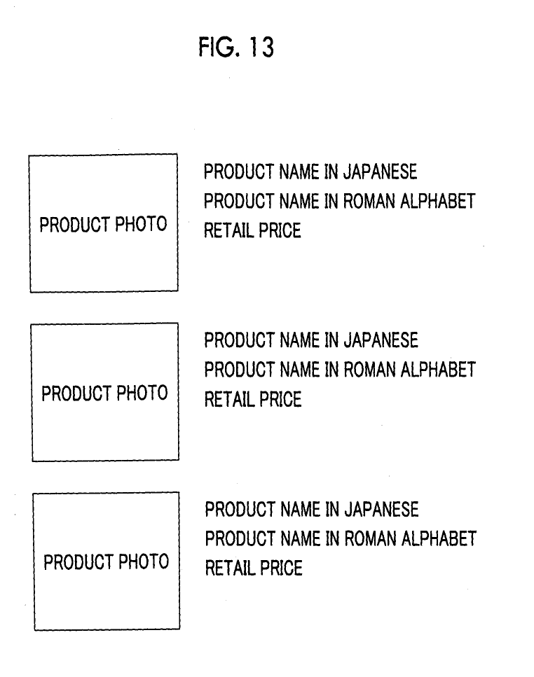

In a second example of the information multilingual conversion system 1 according to the present embodiment, when a foreigner visits an electrical appliance store, a staff at the electrical appliance store accesses to the administrative server 10 by performing a predetermined operation with the use of a portable communication terminal, or the like, and hands the portable communication terminal to the foreigner. When the foreigner selects his or her own understandable language, or the like, with the use of the portable communication terminal, the information display unit 14 displays a list of products as shown in FIG. 13. In this case, information of each product name in Japanese and in Roman alphabet, information of the photo of each product, information of retail price, and the like, should be displayed in a list form.

When a product name, or the like, is selected from the list, the portable communication terminal issues a request to acquire the corresponding display information to the administrative server 10. The information display unit 14 displays the display information of the selected product, corresponding to the language selected by the foreigner, from the display information storage unit 12. The information display unit 14 displays, for example, an appeal point of the product, automatically translated in the selected language. The information display unit 14 may display a floor map that shows the display location of the product.

By displaying the product information as described above, it is possible to provide foreign-language product information. The foreigner is allowed to tell a desired product to the staff, and is allowed to smoothly purchase a desired product.

### Alternative Embodiment to Present Embodiment

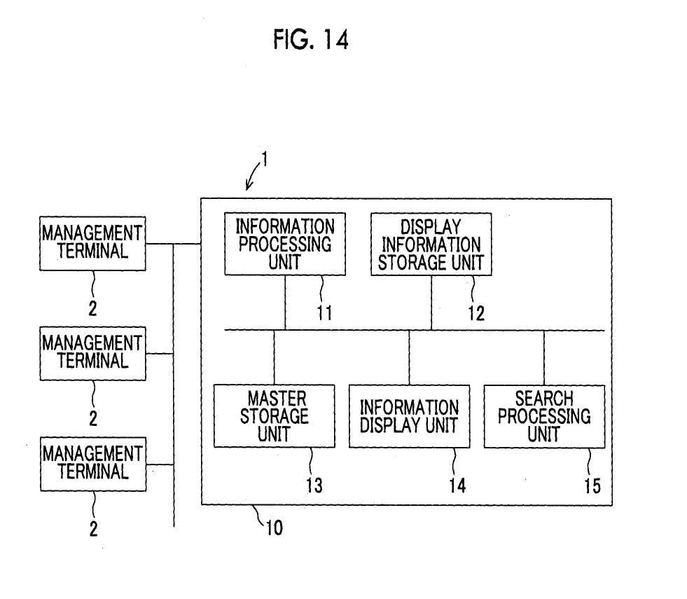

In an embodiment different from the present embodiment, a web server that is utilized by an information providing site that provides information of a sightseeing spot, commercial facility or product may be interlocked with the display information storage unit 12, and the information providing site may receive any one or more of an identification name, a category, an introduction and property information as a search condition for searching for a sightseeing spot, a commercial facility or a product. In this case, as schematically shown in FIG. 14, the administrative server 10 includes a search processing unit 15. A search condition may be input to the web server that is utilized by the information providing site from an information terminal (including the management terminal 2 or a computer that is utilized by a user) configured to be able to browse various pieces of information.

The search processing unit 15 identifies a word in the first language, corresponding to a search condition in the second language (first search condition) from the correspondence foreign-language term storage unit 134 on the basis of any one or more of the identification name, the category, the introduction and the property information in the search condition input to the information providing site. The search processing unit 15 further adds the identified terms to the search condition (second search condition), searches the display information storage unit 12 for a sightseeing spot, a commercial facility or a product, including those terms, and then returns the results to the information providing site.

For example, when a sightseeing spot information providing site receives the input of “shrine” (English) as the first search condition for the identification name, the search processing unit 15 identifies a word “ [symbol] ” (Japanese) (“Shrine” in Kanji) corresponding to the first search condition “shrine” by searching the correspondence foreign-language term storage unit 134 from the sightseeing spot information providing site, and adds the second search condition “ [symbol] ” (“Shrine” in Kanji). The search processing unit 15 searches the display information storage unit 12 for a sightseeing spot of which the display information includes “shrine” and “ [symbol] ” (“Shrine” in Kanji) as the first and second search conditions, and returns the appropriate shrine to the sightseeing spot information providing site as the result.

In this case, the display information of the sightseeing spot that is displayed as the search result should be displayed as information corresponding to the same language as the language of the search condition (first search condition) input to the sightseeing spot information providing site. That is, even when the display information of the appropriate sightseeing spot includes not “shrine” but the search condition “ [symbol] ” (second search condition), not the Japanese display information is displayed but the English display information is desirably extracted from the display information storage unit 12 and displayed.

The process of searching for an identification name by the search processing unit 15 is described. The process of searching for a category or property information is also similarly processed.

By providing the search processing unit 15, information about an appropriate sightseeing spot, commercial facility or product is provided to foreigners via various information providing sites. Even when Japanese writing is not known, it is possible to acquire information about a desired sightseeing spot, commercial facility or product.

The invention described in the specification encompasses not only the configurations of the appended claims and embodiments but also, within an applicable range, configurations specified by changing part of these configurations changed to another configuration described in the specification or configurations specified by adding another configuration described in the specification to these configurations or broader-concept configurations specified by discarding these partial configurations as long as part of operation and advantageous effects are obtained.

With the information multilingual conversion system 1 according to the embodiments of the invention, even when there are no human resources who are conversant in foreign languages, foreigners who visit sightseeing spots or commercial facilities for the first time enjoy sightseeing with a simple method. Because it is possible to display detailed information of a product, foreigners are able to purchase an intended product without any mistake.

1-12 (canceled)

13. An information multilingual conversion system that generates various pieces of information in multiple languages, the information multilingual conversion system comprising:
identification name processing circuitry that receives input of an identification name that identifies the various pieces of information in a first language, and that assigns an identification code to each identification name;
introduction processing circuitry that receives input of an introduction of the various pieces of information in the first language in association with the identification code;
category property information processing circuitry that receives input of at least one of a category and property information of the various pieces of information in association with the identification code;
automatic translation circuitry that translates the introduction, received by the introduction processing circuitry, into a second language;
correspondence foreign-language term storage circuitry that stores a correspondence relation between the first language and the second language for the at least one of the category and the property information;
foreign-language word conversion circuitry that converts the at least one of the category and the property information to the second language by using the correspondence relation between the first language and the second language, stored in the correspondence foreign-language term storage circuitry;
display information storage circuitry that stores, as display information, the identification name received by the identification name processing circuitry, the introduction translated into the second language by the automatic translation circuitry, and the at least one of the category and the property information, converted to the second language by the foreign-language word conversion circuitry; and
information display circuitry that, in response to a display request from an information terminal configured to be able to browse the various pieces of information, displays the display information, stored in the display information storage circuitry, on the information terminal.

14. The information multilingual conversion system according to claim 13, wherein the identification name processing circuitry receives input of at least one of an official name indicating the various pieces of information and a simplified name of the official name as the identification name.

15. The information multilingual conversion system according to claim 13, wherein
the identification name processing circuitry automatically converts the received identification name to an identification name in writing that allows an intended foreigner to pronounce in the first language, and
the display information storage circuitry further stores the identification name, automatically converted by the identification name processing circuitry, as display information.

16. The information multilingual conversion system according to claim 14, wherein
the identification name processing circuitry automatically converts the received identification name to an identification name in writing that allows an intended foreigner to pronounce in the first language, and
the display information storage circuitry further stores the identification name, automatically converted by the identification name processing circuitry, as display information.

17. The information multilingual conversion system according to claim 16, wherein
the information display circuitry extracts at least one of the official name in the first language and the simplified name in the first language, stored in the display information storage circuitry, and at least one of the automatically converted official name in writing that allows the intended foreigner to pronounce in the first language and the automatically converted simplified name in writing that allows the intended foreigner to pronounce in the first language, and displays the at least one of the official name in the first language and the simplified name in the first language and the at least one of the automatically converted official name and the automatically converted simplified name on the information terminal.

18. The information multilingual conversion system according to claim 13, further comprising:
introduction storage circuitry that stores the category and template information of an introduction related to the category in association with each other, wherein
the introduction processing circuitry extracts the template information of the introduction corresponding to the category received by the category property information processing circuitry from the introduction storage circuitry.

19. The information multilingual conversion system according to claim 13, wherein
when the introduction processing circuitry has received input of revision to the introduction in the first language, the automatic translation circuitry automatically translates the introduction, to which the input of revision in the first language has been received by the introduction processing circuitry, into the second language.

20. (Newt The information multilingual conversion system according to claim 13, wherein
when the category property information processing circuitry has received input of revision in the first language to the at least one of the category and the property information, the foreign-language word conversion circuitry automatically converts the at least one of the category and the property information, to which the input of the revision in the first language has been received, into the second language.

21. The information multilingual conversion system according to claim 13, further comprising:
search processing circuitry that receives a first search condition in the second language from the information terminal, that identifies a word in the first language, corresponding to the first search condition, as a second search condition, that searches for display information that is stored in the display information storage circuitry and that is appropriate for the first search condition and the second search condition, and that provides the appropriate display information to the information terminal.

22. The information multilingual conversion system according to claim 21, wherein
the search processing circuitry receives at least one of a category and property information as a category and property information search condition, searches for display information that is stored in the display information storage circuitry and that is appropriate for the category and property information search condition, and provides the appropriate display information to the information terminal.

23. The information multilingual conversion system according to claim 13, wherein
the category property information processing circuitry receives input of positional information, and
the information display circuitry displays the positional information.

24. The information multilingual conversion system according to claim 13, further comprising:
category property information storage circuitry that stores at least one set of categories and pieces of property information, which are choices for receiving input of a selected one of a category and property information, wherein
the category property information processing circuitry extracts choices for at least one of a category and property information, stored in the category property information storage circuitry, on the basis of the at least one set of the categories and the pieces of property information.

25. The information multilingual conversion system according to claim 13, further comprising:
image information processing circuitry that receives input of image information.
